(19) United States
(12) Patent Application Publication
(10) Pub. No.: US 2002/0116286 A1
(43) Pub. Date: Aug. 22, 2002

(54) Method and apparatus for utilizing demand information at a vending machine

(76) Inventors: Jay S. Walker, Ridgefield, CT (US); Daniel E. Tedesco, Huntington, CT (US); John M. Packes JR., Hawthorne, NY (US); Dean P. Alderucci, Stamford, CT (US)

Correspondence Address: WALKER DIGITAL, FIVE HIGH RIDGE PARK, STAMFORD, CT, 06905, US

(21) Appl. No.: 09/994,810

(22) Filed: Nov. 27, 2001

Related U.S. Application Data
(63) Continuation-in-part of application No. 09/164,670, filed on Oct. 1, 1998, now Pat. No. 6,324,520.
Application No. 09/164,670 is a continuation-in-part of application No. 09/012,163, filed on Jan. 22, 1998, now Pat. No. 6,397,193.
Application No. 09/012,163 is a continuation-in-part of application No. 08/947,798, filed on Oct. 9, 1997.

(51) Int. Cl. G06F 17/60

(52) U.S. Cl. 705/26

(57) ABSTRACT

A dispensing device is equipped to monitor product demand and consumer traffic that passes by the machine. The dispensing device collects and analyzes product demand data to determine optimal product stocking, to offer products to undecided consumers and to offer substitute products when a selected product is out of stock. The substitute product may be determined according to which alternate product historically has the highest demand when a particular selected product is unavailable. Alternatively, the substitute product may be determined according to which stocked item has an imminent expiration date. Also, the substitute product may be predetermined by an operator of a vending machine or may be determined by other factors. The substitute product may further be offered to the customer at a discounted price.

The present application is a continuation-in-part of U.S. patent application Ser. No. 09/164,670, which is a continuation-in-part of co-pending U.S. patent application Ser. No. 09/012,163 entitled “METHOD AND APPARATUS FOR AUTOMATICALLY VENDING A COMBINATION OF PRODUCTS” filed on Jan. 22, 1998, which is a continuation-in-part of copending U.S. patent application Ser. No. 08/947,798 entitled “METHOD AND APPARATUS FOR DYNAMICALLY MANAGING VENDING MACHINE INVENTORY PRICES” filed on Oct. 9, 1997. The entirety of each of the above is incorporated herein by reference as part of the present disclosure.

### FIELD OF THE INVENTION

This invention relates generally to dispensing devices.

### BACKGROUND OF THE INVENTION

Modem vending machines typically store and dispense a vast array of merchandise and/or offer various services in response to a customer request accompanied by appropriate payment. Examples of merchandise dispensed by such machines include drinks, candy, frozen deserts, snacks, video tapes and children's toys. Examples of services offered include automated car washes, portrait photographs, laundry machines, television viewing and blood pressure monitoring.

Many entrepreneurs are attracted to the basic concept of selling products and services using a vending machine. Vending machines are generally considered to have significant advantages over traditional merchandising. Specifically, vending machines enable the automated sale of merchandise and services at unconventional locations and times, and they do not require sales personnel.

### BRIEF DESCRIPTION OF THE DRAWINGS

FIG. 1. is a schematic block diagram of a dispensing device in accordance with an embodiment of the present invention.

FIG. 2 is a block diagram illustrating an operator authorization database used by the dispensing device of FIG. 1.

FIG. 3 is a block diagram illustrating a transaction database used by the dispensing device of FIG. 1.

FIG. 4 is a block diagram illustrating a suggestive sell database used by the dispensing device of FIG. 1.

FIG. 5 is a block diagram illustrating an inventory database used by the dispensing device of FIG. 1.

FIG. 6 is a block diagram illustrating a demand database used by the dispensing device of FIG. 1.

FIG. 7 is a flow chart illustrating an embodiment of a process by which an operator can access demand data stored by the dispensing device of FIG. 1.

FIGS. 8A-8C are flow charts illustrating demand monitoring and suggestive sale functions that may be performed by the dispensing device of FIG. 1 in certain embodiments of the present invention.

### DETAILED DESCRIPTION OF THE PREFERRED EMBODIMENTS

Various embodiments of the present invention are advantageous. For example, certain embodiments deal favorably with perishable inventory. Certain embodiments promote the sale of low demand products. Certain embodiments promote the sale of products having quality which are inferior and/or which are perceived to be inferior.

Definitions

The following terms as used herein will be understood to have the following meanings unless otherwise indicated:

Dispensing device: Any device or machine capable of receiving, directly or indirectly, an amount of money or other payment, and providing, directly or indirectly, one or more products.

Product: Anything, including a good and or service, that may be sold or provided using a dispensing device.

Substitute product: A product offered in place of another product.

Predetermined product: A product which is set as a default substitute product.

Product identifier: A designation that corresponds to or otherwise identifies a product.

Expiration date: A date on which a product is no longer (i) suitable for sale, use or consumption, or (ii) desired to be sold, used or consumed.

Availability: Whether a product is (i) able to be dispensed, or (ii) should be dispensed.

Amount of money: A monetary value, such as cash, credit, or electronic cash transferred to or otherwise provided to a dispensing device.

Discounted price: A price of a product which is less than the typical price of the product.

Purchaser: An entity that purchases, attempts to purchase or wishes to purchase a product.

Selection: An indication of one or more products that the purchaser (i) desires to purchase, or (ii) attempts to purchase.

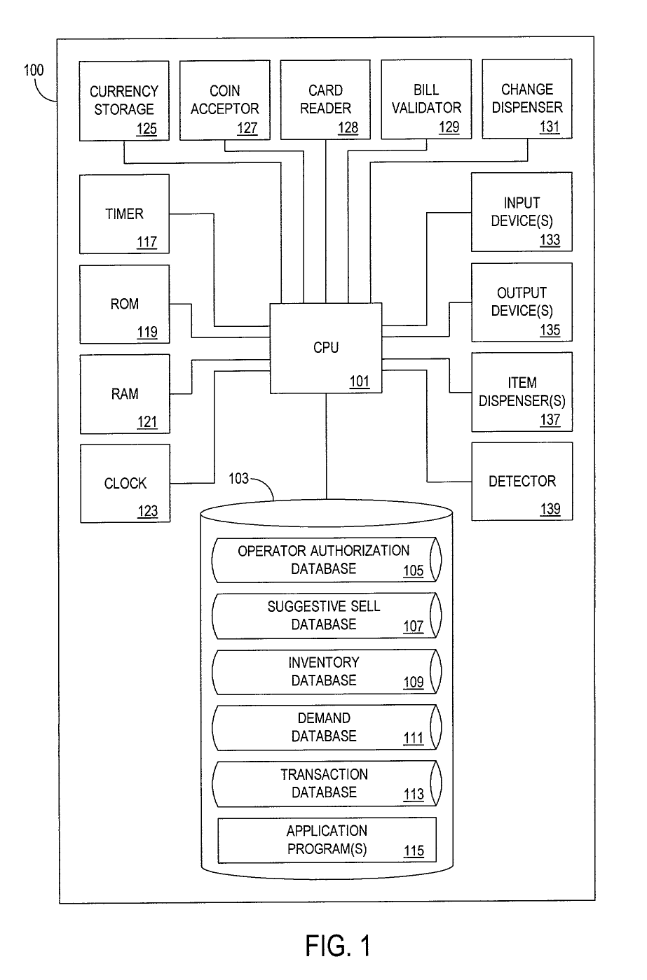

Embodiments of the present invention will now be discussed with reference to FIGS. 1-8C. FIG. 1 displays a schematic block diagram of dispensing device 100 and its components. Dispensing device 100 may be a vending machine, kiosk or any other mechanism by which a purchaser may purchase products. Dispensing device 100 is controlled by central processing unit (CPU) 101 which may comprise one or more commonly manufactured microcontrollers or microprocessors, such as the Pentium 4® manufactured by Intel® Corporation. Central processing unit (CPU) 101 runs at a clock speed determined by clock 123, which is operatively connected to CPU 101.

Central processing unit (CPU) 101 may further be operatively connected to one or more standard computer-based components such as random access memory (RAM) 121, read-only memory (ROM) 119, input device(s) 133, output device(s) 135 and data storage device 103. Random access memory (RAM) 121 may be, for example, one or more single inline memory module (SIMM) chips capable of storing a predetermined amount of data (typically measured in megabytes) and used by central processing unit (CPU) 101 for temporary storage of processing instructions and data during operation of dispensing device 100. Read-only memory (ROM) 119 may comprise at least one permanent non-erasable and non-rewritable memory that stores, e.g., initializing instructions to be used by central processing unit (CPU) 101 during, e.g., a start-up routine performed by dispensing device 100. Further functions of random access memory (RAM) 121 and read-only memory (ROM) 119 will be apparent to one of ordinary skill in the art.

For example, one or more of CPU 101, input devices(s) 133, RAM 121, ROM 119, output device(s) 135 and data storage device 103 may be included, wholly or partially, in a separate device, such as the e-Port™ by USA Technologies Inc., that is in communication with a vending machine (e.g., a vending machine manufactured by Crane Co. or Stentorfield Ltd, an ATM, a kiosk.). The separate device may also be in communication with a network such as the Internet.

The e-Port™ is a credit and smart card-accepting unit that controls access to office and MDB vending equipment, and serves as a point of purchase credit card transaction device. The e-Port™ includes an LCD that allows for the display of color graphics, a touch sensitive input device (touch screen) that allows users to input data to the device. The display may be used to prompt users interactively with, e.g., advertising messages (which may be derived dynamically via a network), an ordering sequence or other instructions, and information about their transaction status. Such information and content can be drawn by the e-Port™ through the Internet or submitted directly to the e-Port™. User response information may be retrieved from the e-Port™ through the Internet or directly, and thereby collected by, e.g., a server in communication with the e-Port™ via a network.

The separate device may alternatively be a programmed computer running appropriate software for performing the necessary functions described herein.

The separate device may be operable to receive input from purchasers, receive payment from purchasers, exchange information with a remotely located server and/or display messages to purchasers. The separate device may be operable to instruct the vending machine that appropriate payment has been received (e.g., via a credit card read by the separate device) and/or that a particular product should be dispensed by the vending machine.

Input device(s) 133 may comprise one or more of the following commonly known peripherals used for inputting data to a dispensing device: a parallel port, a serial port, any port for interfacing with a computing device such as a PDA, cell phone or MP3 player, a keypad, a push button, a microphone, a disk drive such as a floppy disk, DVD or CD drive, and a voice recognition device. Input device(s) 133 may include either or both of (i) an external input device for use by a purchaser and (ii) an internal input device that is accessible by a service or operator of dispensing device 100, e.g., after the device has been opened. In this manner, a purchaser may, e.g., enter his or her selections for products through an external input device, and a service may, e.g., access and update data stored by dispensing device 100 through the internal input device.

Output device(s) 135 may comprise one or more of the following commonly-known peripherals used for outputting data directly or indirectly from a microprocessor: a parallel port, a serial port, any port for interfacing with a computing device such as a PDA, cell phone or MP3 player, a printer, a monitor, an LED display, an LCD display, a speaker or other audio output, a voice synthesizer, a disk drive with write capability such as a floppy disk, DVD or CD drive,.

Output device(s) 135 may include either or both of (i) an external output device for use by a purchaser and (ii) an internal output device that is accessible by a service or operator of dispensing device 100, e.g., after the device has been opened. In this manner, a service may receive data stored by dispensing device 100 through the internal output device. Further applicable output devices will be apparent to one of ordinary skill in the art. Additionally, input device(s) 133 and output device(s) 135 may comprise one device, such as a communications port that can both receive and transmit data.

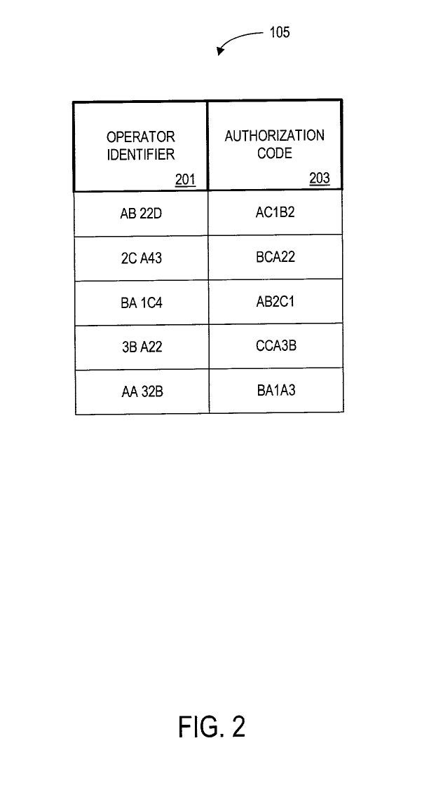

CPU 101 is operatively connected to transmit and receive data from data storage device 103, which may comprise any appropriate combination of semiconductor, magnetic and/or optical media for storing data persistently or transiently. For example, any one of the following commonly known peripherals may be used for storing computer data: a hard drive, a floppy disk drive, a DVD drive of the type manufactured by Philips Electronics, a ZIP drive of the type manufactured by IOMEGA, a tape drive and a Digital Audio Tape drive. Further such devices will be apparent to one of ordinary skill in the art. Data storage device 103 is operative to store operator authorization database 105, suggestive sell database 107, inventory database 109, demand database 111, and transaction database 113, each of which is discussed below with reference to FIGS. 2-6, respectively.

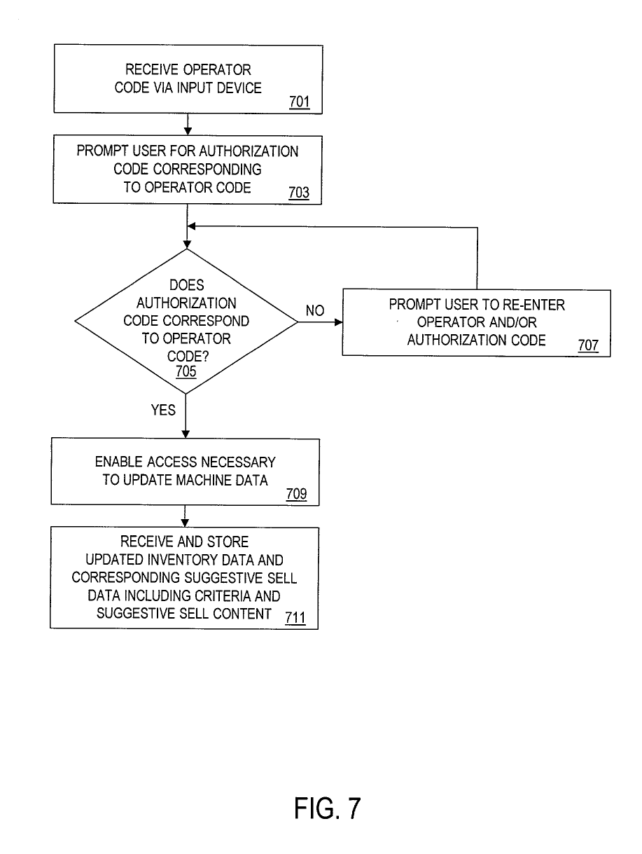

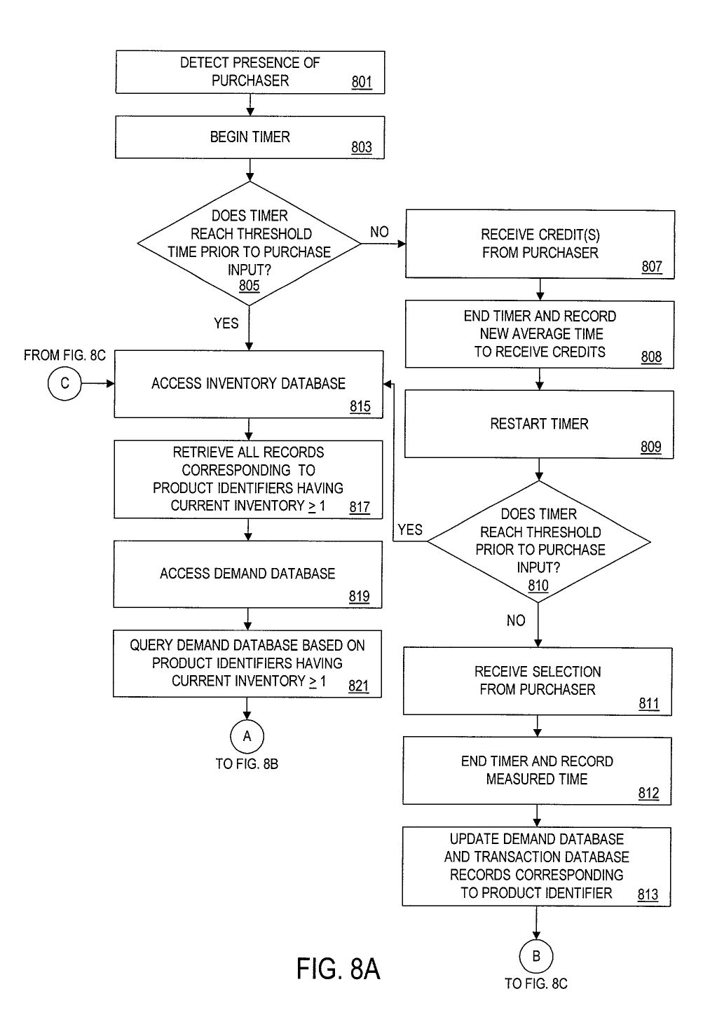

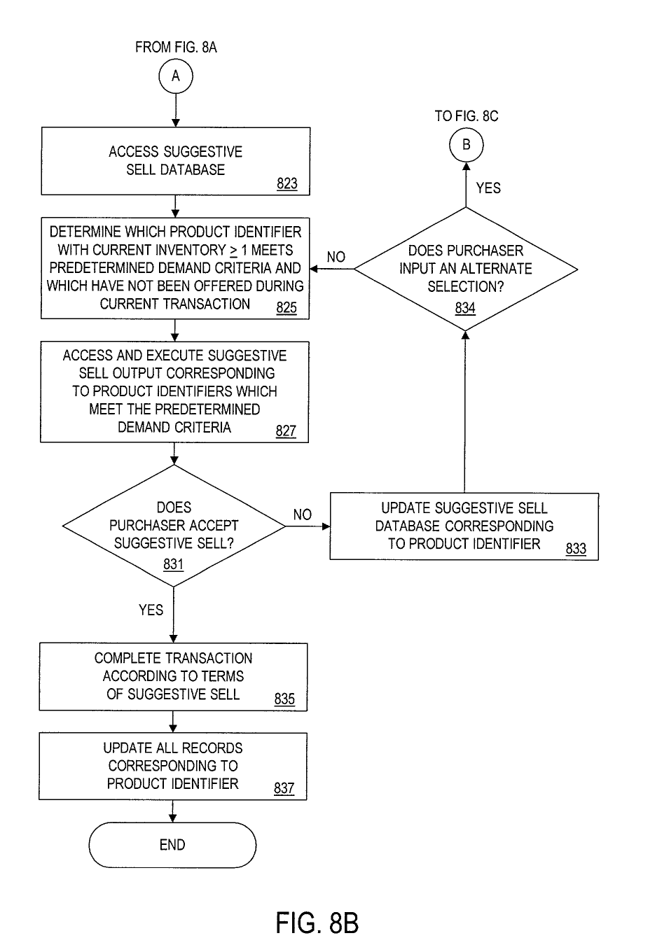

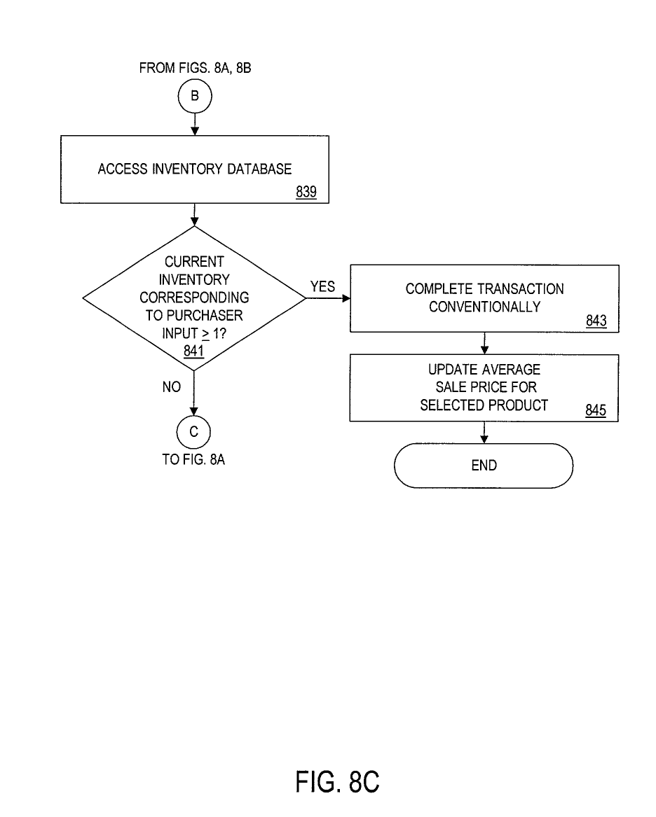

Data storage device 103 may further be operative to store an operating system (not shown) and one or more application programs 115. In accordance with a preferred embodiment of the present invention, the application program(s) 115 contain processing instructions for central processing unit (CPU) 101 to retrieve and perform the operator verification process shown in FIG. 7, and the demand monitoring and suggestive sell functions of FIGS. 8A-8C, each of which is discussed in detail below.

Central processing unit (CPU) 101 is further operatively connected to timer 117 which can be set, reset and read by central processing unit (CPU) 101 to measure the passage of time. Alternatively, central processing unit (CPU) 101 may use signals generated by clock 123 to measure the passage of time in place of timer 117, as will be apparent to one of ordinary skill in the art.

Central processing unit (CPU) 101 is further operatively connected to monitor and operate currency storage 125, coin acceptor 127, card reader 128, bill validator 129, change dispenser 131, item dispenser(s) 137, and detector 139. Currency storage 125 is equipped to store both physical currency and electronic forms of currency, such as e-cash or credits from a debit card, credit card or smart card, received by dispensing device 100. Coin acceptor 127 accepts and determines an amount of money received from coinage deposited into dispensing device 100. Card reader 128 receives electronic currency from a card, such as a smart card, debit card or credit card and/or determines account information for an account owned by the card owner. The account information is stored and used to apply a charge against the account for a product selected and dispensed by dispensing device 100. Bill validator 129 accepts and determines an amount of money received from monetary bills deposited into dispensing device 100.

Change dispenser 131 dispenses any change that is due to a purchaser who deposits money into coin acceptor 127, card reader 128, or bill validator 129. The amount of change to be dispensed is determined by central processing unit (CPU) 101 by using one of the application program(s) 105. In a process not shown, but apparent to one of ordinary skill in the art, central processing unit (CPU) 101 determines an amount of money that a purchaser has deposited, recognizes a product that the purchaser has selected and calculates the difference between the amount of money deposited and the amount to be charged for the product. The difference is dispensed to the purchaser through change dispenser 131. Change dispenser 131 may be operatively connected to currency storage 125 (not shown) to dispense change from that device.

Detector 139 is a device that sends a signal to central processing unit (CPU) 101 when a purchaser is detected near dispensing device 100. Detector 139 is used by dispensing device 100 to initiate the demand monitoring and suggestive sell functions discussed further below with regard to FIGS. 8A-8C. Detector 139 may be any of the following types of devices: a motion detector, an infrared detector, an acoustic signal detector, a pressure detector mounted on the floor in front of dispensing device 100 or any other device that may detect a presence of a purchaser when he or she is in proximity of dispensing device 100 and which outputs a signal indicative of the presence of the purchaser.

Referring now to FIG. 2, operator authorization database 105 stores operator identifiers and corresponding authorization codes which are required to be entered in order to access data stored in dispensing device 100. Each record in operator authorization database 105 contains an entry in operator identifier field 201 and authorization code field 203. Operator identifier field 201 preferably lists several codes, each of which are assigned to a particular operator or service authorized to access data stored by dispensing device 100. Each such code in operator identifier field 201 has a corresponding unique authorization code stored in authorization code field 203. Upon accessing dispensing device 100, an operator must enter, through input device(s) 133, a valid operator identifier code and the authorization code assigned to that identifier. Upon entry of the information, central processing unit (CPU) 101 refers to operator authorization database 105 and confirms that the entered information matches a record in operator authorization database 105. As discussed further with regard to FIG. 7, if the information matches, the operator is allowed to access and update data stored in data storage device 103 of dispensing device 100. If the information does not match, the operator is denied access to the machine.

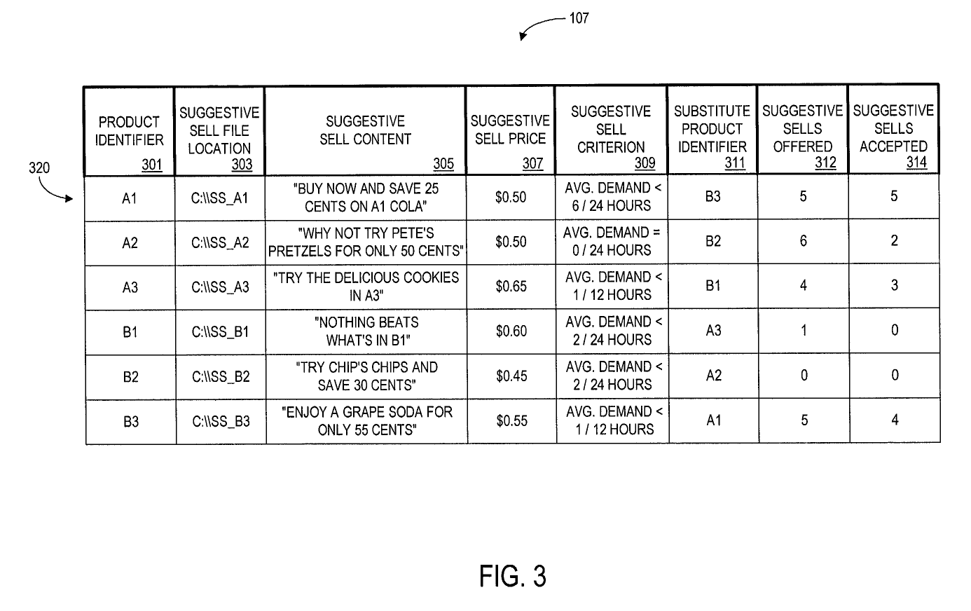

FIG. 3 displays the exemplary contents of suggestive sell database 107 which is maintained by dispensing device 100 for implementing the suggestive sale functions performed, as described further with regard to FIGS. 8A-8C. A suggestive sell is an offer to sell a product. Such offers are typically made by the dispensing device, but may be made by other devices with or without the direction of the dispensing device. In several embodiments of the present invention, the suggestive sell is offered when (i) no product has yet been selected by a purchaser, (ii) a product selected by a purchaser is unavailable, and/or (iii) a product selected by a purchaser is not desirable (for various reasons) to sell to the purchaser. For example, it may be desirable to reserve a selected product for a future purchaser rather than sell it to the instant purchaser. This can occur, e.g., when the product is likely to sell later and/or when the product is the subject of a subscription or other agreement to purchase.

Each record of suggestive sell database 107 contains an entry in product identifier field 301, suggestive sell file location field 303, suggestive sell content field 305, suggestive sell price field 307, suggestive sell criterion field 309, substitute product identifier field 311, suggestive sells offered field 312 and suggestive sells accepted field 314.

In certain embodiments, each entry in product identifier field 301 corresponds to one product offered by dispensing device 100. A unique product identifier is assigned to each type of product or, alternatively may correspond to a rack or shelf (not shown) in dispensing device 100 on which the product is stored and/or displayed and/or from which the product is dispensed. For each product identifier, an entry of a suggestive sell file is made in suggestive sell file location field 303. The suggestive sell file location is preferably an address of a data file stored in storage device 103. The data file may contain audio or textual information that is output to a purchaser during the suggestive sell functions described further in conjunction with FIGS. 8A-8C. The audio and textual information is preferably a description of a suggestive sell being offered to a purchaser during a transaction.

For each product identifier, an entry is also made in suggestive sell content field 305. The suggestive sell content lists the text or audio message stored at the location stored in suggestive sell file location field 303. The information in this field preferably corresponds to the audio or textual information that is to be presented to a purchaser during the suggestive sell functions performed by dispensing device 100, discussed further in conjunction with FIGS. 8A-8C.

For each product identifier, an entry is also made in suggestive sell price field 307. The suggestive sell price is a discounted price, preferably determined by an operator of dispensing device 100, for which a product will be offered during the suggestive sell function discussed further in conjunction with FIGS. 8A-8C.

For each product identifier, an entry is also made in suggestive sell criterion field 309. The suggestive sell criterion is preferably defined and entered by an operator of dispensing device 100. The suggestive sell criterion may be a requirement that the average demand for a product associated with the criterion is below a certain average demand rate. Additional and/or alternate suggestive sell criteria may be included as will be apparent to one of ordinary skill in the art. In any event, if the suggestive sell criterion is met, the product associated with the criterion is eligible to be offered in the suggestive sell function described in conjunction with FIGS. 8A-8C.

For each product identifier entered in product identifier field 301, a substitute product identifier is entered in substitute product identifier field 311. The substitute product identifier is meant to identify a product to be offered when an initial product selection is not available. For example, referring to record 320 of FIG. 3, if product A1 is selected by a purchaser and is not available, then the machine will offer product B3 as a suggestive sell.

The substitute product to be offered may be operator-selected or may be determined by the dispensing device 100 after an analysis of demand data has been performed. In various embodiments of the present invention, demand for a product may be based on the number of times the product was selected for purchase. In other embodiments, demand may be measured in different ways and based on different information. For example, demand for a product may be based on information regarding subscriptions for the product. Subscriptions at dispensing devices is described in U.S. Pat. Nos. 5,988,346 and 6,298,972, each of which are incorporated herein by reference as part of the present disclosure. As an example, subscriptions to a first product may imply that a certain number (e.g., seventy units) of the first product will be (or probably will be) dispensed from a first dispensing device(s) during a predetermined interval (e.g., the current month). Accordingly, this expected number of the first product may be used to derive the demand for the first product.

For example, CPU 101 may be programmed to track and store which product is most often selected after an initially selected product is identified as being unavailable. In one embodiment, a product identifier corresponding to the most often alternately-selected product may then be stored as a substitute product in substitute product identifier field 311. Other criteria may be employed in programming the device to determine a substitute product. These criteria may include: which product has been stocked most recently (as may be determined by examining stock date field 409); which product is due to be restocked at the earliest date (as may be determined from restock date field 411); or which product will expire at the earliest date (as may be determined from product expiration date field 413). Other criteria may be employed in making the determination as to which product will act as a substitute product, as will be apparent to one of ordinary skill in the art.

Preferably, a substitute product identifier is listed for each product identifier in product identifier field 301. The substitute product identifier, furthermore, preferably corresponds to an existing product which is already listed in product identifier field 301. Hence, any product in substitute product field is preferably listed in product identifier field 301. However, for each record in suggestive sell database 107 the value listed in product identifier field 301 should not be the same product identifier listed in substitute product identifier field 311.

Suggestive sells offered field 312 of suggestive sell database 107 lists the number of times a product corresponding to the product identifier was offered in a suggestive sell. Suggestive sells accepted field 314 lists the number of times the product was accepted as a suggestive sell. This information is measured and recorded during the suggestive sell functions described in accordance with FIG. 8B. The information in these fields is useful to an operator of dispensing device 100, or to the dispensing device itself, to determine the effectiveness of a suggestive sell for each of the products. For example, in the case where a product is offered through a suggestive sell many times, but is rarely accepted, the operator or dispensing device 100 may adjust the terms of the suggestive sell offered so that the acceptance rate increases. This may be accomplished, for example, by decreasing the suggestive sell price for the product, or by determining a suitable substitute product and changing the substitute product identifier of field 311. Methods for allowing a dispensing device 100 to determine suitable substitute products and/or adjust suggestive sell prices are discussed further in co-pending U.S. patent application Ser. No. 08/947,798 entitled “METHOD AND APPARATUS FOR DYNAMICALLY MANAGING VENDING MACHINE INVENTORY PRICES” filed on Oct. 9, 1997 in the name of Daniel E. Tedesco, James A. Jorasch and Robert R. Lech and co-pending U.S. patent application Ser. No. 09/012,163 entitled “METHOD AND APPARATUS FOR AUTOMATICALLY VENDING A COMBINATION OF PRODUCTS” filed on Jan. 22, 1998 in the name of Daniel E. Tedesco, James A. Jorasch, Jay S. Walker and Robert R. Lech, both incorporated herein by reference.

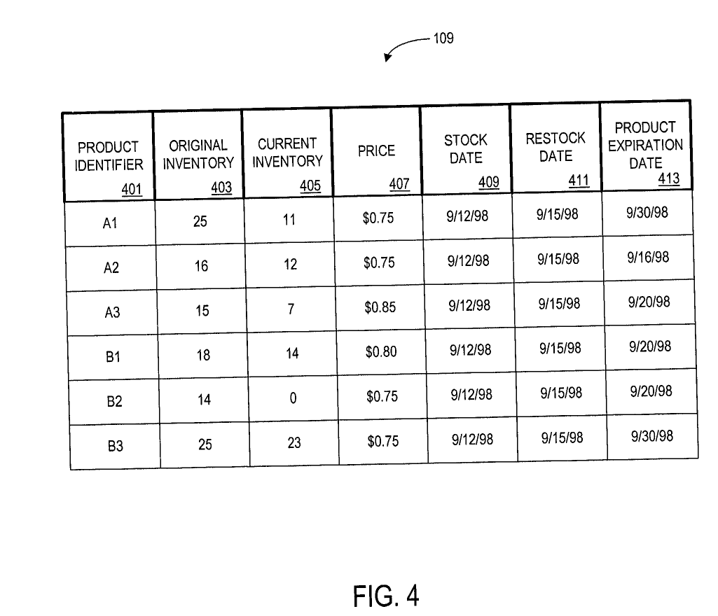

FIG. 4 displays the preferred contents of inventory database 109. For each record in inventory database 109, an entry is stored in product identifier field 401, original inventory field 403, current inventory field 405, price field 407, stock date field 409, restock date field 411 and product expiration date field 413.

Preferably, each entry in product identifier field 401 corresponds to one product offered by dispensing device 100. Furthermore, the entries in product identifier field 401 may correspond to the entries made in product identifier field 301 of suggestive sell database 107. Each identifier listed in product identifier field 401 is preferably a unique identifier that corresponds to a single product offered by the machine. As described above, the product identifier may correspond to a rack or shelf (not shown) in dispensing device 100 on which the product is stored and/or displayed.

For each product identifier in product identifier field 401, an entry is made in original inventory field 403 that represents the number of the product originally placed for dispensing in dispensing device 100. Current inventory field 405 contains an entry, preferably maintained by dispensing device 100, corresponding to the amount of the product remaining in dispensing device 100. Price field 407 contains an entry, for each product, representing the original, non-discounted price at which the product is offered for purchase. Stock date field 409 lists, for each product, the date on which the product was placed in the dispensing device 100. Restock date field 411 lists, for each product, a date on which the product is expected to be re-stocked by an operator of dispensing device 100. Finally, product expiration date field 413 lists, for each product, a date on which the product is no longer suitable for use or consumption.

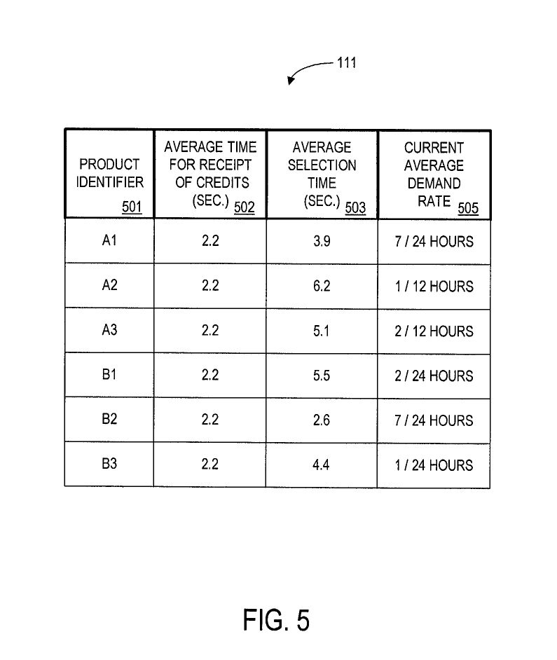

FIG. 5 displays demand database 111 which contains database records having a product identifier field 501, average time for receipt of credits field 502, average selection time field 503 and current average demand rate field 505. Preferably, each entry product identifier field 501 corresponds to one product offered by dispensing device 100. Furthermore, the entries in product identifier field 501 may correspond to the entries made in product identifier field 301 of suggestive sell database 107. Each product identifier listed in product identifier field 501 is preferably a unique identifier that corresponds to a single type of product offered by the machine. Alternately, as described above, the product identifier may correspond to a rack or shelf (not shown) in dispensing device 100 on which the type of product is stored and/or displayed.

Average time for receipt of credits field 502 lists, for each product, an average amount of time taken by purchasers to input an amount of credits after detection of the customer by detector 139 of dispensing device 100. This information is used by dispensing device 100 to determine a time after which to offer a suggestive sell, as discussed further in regard to FIGS. 8A-8C.

Average selection time field 503 lists, for each product, an average amount of time taken by purchasers to select the corresponding product. The average selection time may be determined differently in various embodiments of the present invention. For example, the average selection time may be based on a starting time such as the initial detection of a purchaser or an input of (partial or full) payment by the purchaser. The average selection time may alternatively or additionally be based on an ending time such as an input of (partial or full) payment by the purchaser or receipt of a selection (e.g., from a purchaser). The average selection time may be determined by the dispensing device 100, or by another means. In various embodiments, the average selection time may be used by dispensing device 100 to determine a time after which to offer a suggestive sell, as discussed further in regard to FIGS. 8A-8C.

Current average demand rate field 505 lists, for each product, a current rate of demand for the corresponding product. The demand rate for a product is preferably determined by measuring the number of times the product was selected over an amount of time, i.e. 12 selections of the product every 24 hours. This information is used by dispensing device 100 to determine a time after which to offer a suggestive sell, as discussed further in regard to FIGS. 8A-8C.

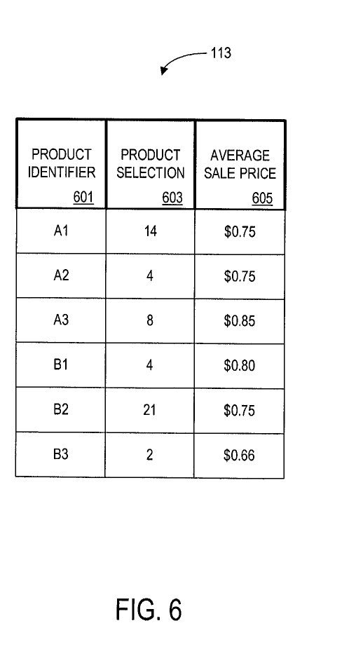

FIG. 6 displays the contents of transaction database 113 which contains database records having a product identifier field 601, a product selection field 603 and an average sale price field 605. Preferably, each entry in product identifier field 601 corresponds to one type of product offered by dispensing device 100. Furthermore, the entries in product identifier field 601 may correspond to the entries made in product identifier field 301 of suggestive sell database 107. Each identifier listed in product identifier field 601 is preferably a unique identifier that corresponds to a single type of product offered by the machine. As described above, the product identifier may correspond to a rack or shelf (not shown) in dispensing device 100 on which the product is stored and/or displayed.

Product selection field 603 lists, for each product, a number of times the product was selected by a purchaser. Average sale price field 605 lists, for each product, the average sale price for which a corresponding product was sold. The average sale price is determined, preferably, by counting the number of times a product was sold and at what price (either the original price or suggestive sell price) the product was sold in each instance. The average sale price may then be determined by calculating the sum of the sale prices and dividing by the number of product sales. Other methods will be apparent to one of ordinary skill in the art. The average sale price field contains data which may be useful to the operator of dispensing device 100 in determining the profitability of each product sold. The information in average sale price field 605 is updated during the demand monitoring and suggestive sell functions described in conjunction with FIGS. 8A-8C below.

Turning now to FIG. 7, a process by which an operator can access and update data stored by the dispensing device 100 is displayed. This process is preferably performed by central processing unit (CPU) 101 in conjunction with at least one of the application program(s) 115.

To perform the accessing process, an operator preferably gains access to the internal components of dispensing device 100. The operator, through input device(s) 133 inputs commands to CPU 101 that initiates the accessing process. At step 701, the operator inputs an operator code via input device(s) 133. The operator code is read by CPU 101. At step 703, the CPU 101 prompts the operator, through output device(s) 135, to enter the corresponding authorization code. At step 705, after the operator has input the authorization code, CPU 101 accesses operator authorization database 105 and confirms that the operator identifier code and authorization code are valid. If the codes are both valid, the process continues on to step 709, discussed below. If the codes are not valid, the process proceeds to step 707 where the operator is prompted to re-enter the correct codes. Steps 701, 703, 705, and 707 may be repeated any number of times until the correct codes are entered, or may be terminated after a predetermined number of times.

After an entry of a correct operator code and a correct corresponding authorization code, the process continues to step 709 where the operator is allowed to transmit data through input device(s) 133 and receive data through output device(s) 135 from storage device 103. At step 711, CPU 101 receives any updated inventory data and corresponding suggestive sell data. CPU 101 stores the received inventory data in inventory database 109 and stores any received suggestive sell data in suggestive sell database 107. For example, any received suggestive sell criterion data will be stored in suggestive sell criterion field 309 and any received suggestive sell content data will be stored in suggestive sell content field 305. The received data is stored in the appropriate database fields as will be apparent to one of ordinary skilled in the art. After step 711, the accessing process ends.

Turning now to FIG. 8A, the process by which CPU 101 performs demand monitoring and suggestive sale functions begins at step 801 where detector 139 sends a signal to CPU 101 indicating that a purchaser is present in front of dispensing device 100. At step 803, CPU 101 measures the time beginning from the detection of the customer. This may be accomplished by sending a start signal to timer 117 or by measuring the time using clock 123 as discussed previously with regard to FIG. 1. At step 805, CPU 101 measures the amount of time passed since the purchaser was detected and compares it to an average time stored, for example, in average time for receipt of credits field 502. If the measured time reaches the average time stored in field 502, the process continues at step 815. Otherwise the process continues at step 807.

At step 807, dispensing device 100 receives a number of credits from the purchaser. At step 808, CPU 101 stops measuring the time passed since detection, determines a new average time for receipt of credits from a purchaser using the latest measured time and stores the value in field 502. At step 809, CPU 101 preferably starts a new measurement of time starting from the receipt of credits from the purchaser. This may be accomplished by sending a start signal to timer 117 or by measuring the time using clock 123 as discussed previously with regard to FIG. 1. At step 810, CPU 101 measures the amount of time passed since the purchaser has input credits and compares it to the average times stored in average selection time field 503. The time passed since the purchaser has input credits may be measured from the time a first credit (such as a coin) has been deposited in either coin dispenser 127, card reader 128 or bill validator 129.

Since, in the preferred embodiment, different average selection times are stored for each product, CPU 101 determines a threshold time by comparing the measured time to one of: the lowest average selection time stored in average selection time field 503, the highest average selection time stored in average selection time field 503 or an average of the average selection times stored in average selection time field 503. If the measured time reaches the threshold time, the process continues at step 815, discussed further below. Otherwise the process continues at step 811.

At step 811, a selection of a product is made by the purchaser. At step 812, CPU 101 stops measuring the time passed since the purchaser input credits, determines a new average time selection time for the product selected by the purchaser based on the latest measured time and stores the value in field 502 for the record corresponding to the selected product. At step 813, CPU 101 updates the new current average demand rate in field 505 and increments the product selection field 603 of transaction database 113 for the product identifier corresponding to the selected product. The process then continues on to step 839, discussed further below in conjunction with FIG. 8C below.

If previously at step 805 the threshold time has been reached, the process continues at step 815 where CPU 101 accesses inventory database 109. At step 817, CPU 101 searches current inventory field 405 of inventory database 109 for all product identifiers having a current inventory greater than or equal to one. At step 819, CPU 101 then accesses demand database 111. At step 821, CPU 101 determines, from current average demand field 505 of demand database 111, the current average demand rate for each product identifier having a current inventory greater than or equal to one. The process then continues at step 823.

Referring now to FIG. 8B, at step 823, CPU 101 next accesses suggestive sell database 107. At step 825, CPU 101 determines, for the product identifier or identifiers having a current inventory greater than one, which product demand data meets the criteria listed in suggestive sell criterion field 309 of database 107. CPU 101 then determines which of these product identifiers have not already been selected by or suggested to the purchaser during the present transaction. This may be accomplished, for example, by tracking which products have been offered during the present transaction, and storing the tracking information temporarily in either data storage device 103 or random access memory 121.

CPU 101 next determines which of the remaining product identifier(s) to offer to the purchaser as a suggestive sell. In the case where more than one product identifier remains after all the above criteria have been applied, CPU 101 may analyze further criteria to determine which product to offer as a suggestive sell. For example, CPU 101 may be programmed to determine which of the remaining products has the highest overall demand rate (as can be readily determined by comparing the values in current average demand rate field 505) and use that product in the subsequent steps relating to a suggestive sell. Alternatively, CPU 101 may be programmed to select the remaining product with the lowest overall demand rate in an effort to sell products with weak demand. Furthermore, CPU 101 may simply select a substitute product listed in substitute product identifier field 311, if a purchaser has already selected a product which is out of stock or otherwise unavailable. Further criteria include which product has been stocked most recently (as may be determined by comparing the values stored in stock date field 409), which product is due to be restocked earlier (as may be determined from restock date field 411) or which product will expire earlier (as may be determined from product expiration date field 413). Other criteria may be employed in making the determination as to which product to offer in a suggestive sell, as will be apparent to one of ordinary skill in the art.

After a product identifier has been determined in step 825, the process continues at step 827 where CPU 101 determines the suggestive sell file location corresponding to that product identifier by accessing suggestive sell file location field 303. The information in the file is then displayed or broadcast to the purchaser, as discussed above with regard to FIG. 3. Also as discussed, the information may correspond to the data listed in suggestive sell content field 305. Furthermore, the product to be offered through a suggestive sell may be offered at the suggestive sell price listed in suggestive sell price field 307.

At step 831, CPU 101 determines whether the purchaser accepts the suggestive sell. This may be determined by ascertaining whether the purchaser has input the selection corresponding to the product identifier offered in the suggestive sell. If the suggestive sell is accepted, the process continues to step 835, discussed below. Otherwise, the process continues to step 833.

At step 833, CPU 101 increments the record in suggestive sell offered field 312 corresponding to the product identifier offered during the suggestive sell. At step 834, CPU 101 determines whether the purchaser inputs an alternate selection. If so, the process continues to step 839, discussed below in conjunction with FIG. 8C. If not, the process returns to step 825, discussed above, and can be repeated any number of times until there are no further products which have not been offered to the purchaser.

At step 835, after the purchaser accepts the product that is offered through the suggestive sell, CPU 101 completes the transaction by, for example, dispensing the product to the customer and dispensing any change due through change dispenser 131. At step 837, CPU 101 updates all records corresponding to the product identifier that are affected by the transaction. The updates preferably include: incrementing suggestive sell offered field 312, incrementing suggestive sell accepted field 314, decrementing current inventory field 405, updating current average demand rate field 505, incrementing product selection field 603 and updating average price field 605 by recalculating the average price by including the price for which the product was sold according to the suggestive sell. After step 837, the demand monitoring and suggestive sell functions end.

Referring now to FIG. 8C, from either step 813 or step 834, the process continues at step 839 where CPU 101 accesses inventory database 109. At step 841, CPU 101 determines the current inventory for a selected product by retrieving the appropriate value stored in current inventory field 405. CPU 101 then determines whether the current inventory for the product selected by the purchaser is at least one, thereby determining whether any of the selected product remains in dispensing device 100. If the current inventory of the selected product is zero, the process returns to step 815. Otherwise the process continues on to step 843 wherein the transaction is completed. This is accomplished, for example, when dispensing device 100 dispenses the selected product to the customer and dispenses any change due through change dispenser 131.

Next, at step 845, the average sale price for the product identifier corresponding to the selected product is updated according to the sales data from the current transaction. The new average sale price is determined and stored in average sale price field 605, after which the process ends.

While the best mode contemplated for carrying out the invention has been described in detail in the foregoing, those of ordinary skill in the art to which the instant invention relates will recognize various alternative designs and embodiments for practicing the invention. For example, various components, steps and limitations described herein may be included in some, but not required in all, embodiments of the invention. Various steps may be performed by entities/components different than those of the various embodiments described herein.

The processes described herein may be performed wholly or partially manually. The processes described herein may be performed wholly or partially by a computing device. With respect to the processes described herein, a device readable medium may be encoded with processing instructions for directing a processor or other device to perform the process. Similarly, an apparatus including a processor and appropriate instructions may perform the processes described herein.

The database structures described above and in the figures may be rearranged, fields may be added or deleted, the databases may be consolidated, or the database(s) otherwise altered. Furthermore, though a stand-alone dispensing device has been described in various embodiments, it is contemplated that the dispensing machine may be a networked device with the ability to store data either locally or at an alternate, networked location. Further, the dispensing device may comprise one or more devices, such as separate devices for receiving payments and for providing products. Such alternative embodiments are contemplated to be within the scope of the instant invention. Accordingly, it is to be understood that the foregoing description is provided for illustrative purposes only and does not limit the scope of the instant invention, as defined by the appended claims.

We claim:

1. A method for dispensing a substitute product, comprising:
receiving a selection of a first product from a purchaser; and
if the first product is not available,
retrieving a substitute product identifier corresponding to a substitute product; and
offering the substitute product to the purchaser.

2. The method of claim 1, further comprising:
receiving an amount of money from a purchaser.

3. The method of claim 2, further comprising:
detecting the purchaser;
measuring a time between a detection and a receipt of the amount of money from the purchaser; and
storing a value corresponding to the time.

4. The method of claim 3, wherein the detecting step is performed by at least one of:
a motion detector, an infrared detector, an acoustic signal detector, and a pressure detector.

5. The method of claim 2, further comprising:
measuring a time between a receipt of the amount of money and a receipt of the selection; and
storing a value corresponding to the time.

6. The method of claim 1, further comprising:
determining an availability of the first product.

7. The method of claim 1, further comprising:
recording a value corresponding to the selection of the first product.

8. The method of claim 7, wherein the value includes one of: a first product identifier corresponding to the first product, a time the first product was selected, a date the first product was selected and an availability of the first product.

9. The method of claim 1, further comprising:
storing, for the first product, a substitute product identifier corresponding to a substitute product.

10. The method of claim 9, wherein the step of storing a substitute product identifier further comprises:
measuring a second product demand corresponding to a number of times the second product is selected when the first product is unavailable; and
if the second product demand meets a predefined criterion,
storing a second product identifier corresponding to the second product as the substitute product identifier.

11. The method of claim 10, further comprising:
measuring a third product demand corresponding to a number of times a third product is selected when the first product is unavailable.

12. The method of claim 11, wherein the predefined criterion comprises a requirement that the second product demand is higher than the third product demand.

13. The method of claim 9, further comprising:
storing a first expiration date corresponding to the second product; and
storing a second expiration date corresponding to a third product,
determining whether the first expiration date is earlier than the second expiration date, and if the first expiration date is earlier:
storing a second product identifier corresponding to the second product as the substitute product identifier.

14. The method of claim 9, wherein the substitute product identifier corresponds to a predetermined product.

15. The method of claim 9, further comprising:
measuring a demand for each of a plurality of products stored in the dispensing device.

16. The method of claim 15, wherein the offering step further comprises:
determining a second product demand for the second product, and if the second product demand is higher than the demand for each of the plurality of products:
storing a second product identifier corresponding to a second product as the substitute product identifier.

17. The method of claim 1, wherein the offering step further comprises:
offering the substitute product to the consumer at a discounted price.

18. The method of claim 1, further comprising:
detecting the purchaser;
measuring a time between a detection of the purchaser and a receipt of the selection from the purchaser; and
storing a value corresponding to the time.

19. The method of claim 18, wherein the detecting step is performed by at least one of:
a motion detector, an infrared detector, an acoustic signal detector, and a pressure detector.

20. The method of claim 1, further comprising:
measuring an average selection time.

21. The method of claim 20, further comprising:
measuring a demand for each of a plurality of products stored in the dispensing device.

22. The method of claim 21, further comprising:
determining which of the plurality of products has a highest demand.

23. The method of claim 22, further comprising:
detecting the purchaser;
measuring a time that passes after detecting the purchaser; and
if, prior to the receiving step, the time is greater than the average selection time,
offering the first product to the purchaser.

24. The method of claim 23, wherein the detecting step is performed by at least one of:
a motion detector, an infrared detector, an acoustic signal detector, and a pressure detector.

25. The method of claim 23, wherein the step of offering the first product to the purchaser further comprises:
offering the first product to the purchaser at a discounted price.

26. The method of claim 23, wherein the first product has the highest demand.

27. The method of claim 23, wherein the first product has the lowest demand.

28. The method of claim 23, further comprising:
comparing at least a first product expiration date corresponding to the first product and a second product expiration date corresponding to a second product.

29. The method of claim 28, wherein the step of offering the first product to the purchaser further comprises:
offering the first product to the purchaser if the first product expiration date is earlier than the second product expiration date.

30. The method of claim 1, wherein the first product is a service.

31. The method of claim 1, wherein the substitute product is a service.

32. A method for dispensing a substitute product, comprising:
measuring a demand for each of a plurality of products;
determining from the demand a substitute product for a first product; and
storing, for the first product, a substitute product identifier corresponding to the substitute product.

33. The method of claim 32, further comprising:
receiving a selection of the first product;
determining an availability of the first product; and
offering the substitute product if the first product is unavailable.

34. The method of claim 33, wherein the step of offering the substitute product further comprises:
offering the substitute product at a discounted price.

35. The method of claim 32, further comprising:
detecting a purchaser;
measuring a time between a detection of the purchaser and a receipt of an amount of money from the purchaser; and
storing a value corresponding to the measured time.

36. The method of claim 35, wherein the detecting step is performed by at least one of:
a motion detector, an infrared detector, an acoustic signal detector, and a pressure detector.

37. The method of claim 32, further comprising:
detecting a purchaser;
measuring a time between a detection of the purchaser and a receipt of a selection from the purchaser; and
storing a value corresponding to the measured time.

38. The method of claim 37, wherein the detecting step is performed by at least one of:
a motion detector, an infrared detector, an acoustic signal detector, and a pressure detector.

39. The method of claim 32, further comprising:
determining an average selection time.

40. The method of claim 39, further comprising:
determining which of the plurality of products has a highest demand.

41. The method of claim 40, further comprising:
detecting a purchaser;
measuring a time that passes after a detection of the purchaser; and
if, prior to the step of receiving a selection, the time is greater than the average selection time,
offering the first product to the purchaser.

42. The method of claim 41, wherein the detecting step is performed by at least one of:
a motion detector, an infrared detector, an acoustic signal detector, and a pressure detector.

43. The method of claim 41, wherein the first product has the highest demand.

44. The method of claim 41, further comprising:
retrieving at least a first product expiration date corresponding to the first product and a second product expiration date corresponding to the second product.

45. The method of claim 44, wherein the offering step further comprises:
determining whether the first product expiration date is earlier than the second product expiration date, and if the first product expiration date is earlier,
offering the first product to the purchaser.

46. The method of claim 39, further comprising:
determining which of the plurality of products has the lowest demand.

47. The method of claim 46, further comprising:
detecting a purchaser;
measuring a time that passes after a detection of the purchaser; and
if, prior to the step of receiving a selection, the time is greater than the average selection time,
offering the first product to the purchaser.

48. The method of claim 47, wherein the detecting step is performed by at least one of:
a motion detector, an infrared detector, an acoustic signal detector, and a pressure detector.

49. The method of claim 46, wherein the first product has the lowest demand.

50. The method of claim 49, wherein the offering step further comprises:
offering the first product to the purchaser at a discounted price.

51. The method of claim 32, wherein the first product is a service.

52. The method of claim 32, wherein the substitute product is a service.

53. A method for dispensing a substitute product, comprising:
determining an average selection time;
detecting a purchaser;
measuring a time from a detection of the purchaser; and
if the time is greater than the average selection time;
offering a first product to the purchaser.

54. The method of claim 53, wherein the detecting step is performed by at least one of:
a motion detector, an infrared detector, an acoustic signal detector, and a pressure detector.

55. The method of claim 53, further comprising:
measuring a first product demand corresponding to the first product; and
measuring a demand for each of a plurality of remaining products; and
comparing the first product demand to the demand for each of the plurality of remaining products.

56. The method of claim 55, wherein the offering step further comprises:
offering the first product to the purchaser if the first product demand is greater than the demand for each of the plurality of remaining products.

57. The method of claim 55, wherein the offering step further comprises:
offering the first product to the purchaser if the first product demand is lower than the demand for each of the plurality of remaining products.

58. The method of claim 53, further comprising:
storing a first product expiration date corresponding to the first product; and
storing at least one expiration date corresponding to each of a plurality of remaining products.

59. The method of claim 58, further comprising:
offering the first product to the purchaser if the first product expiration date is earlier than the at least one expiration date.

60. The method of claim 53, wherein the first product is a predetermined product.

61. The method of claim 53, wherein the first product is a service.

62. A method for measuring a demand of an unavailable product offered by a dispensing device, comprising:
receiving a selection of a product;
determining an availability of the product; and
if the product is unavailable:
storing an indication that the selected product is unavailable.

63. The method of claim 62, wherein the product is a service.

64. An apparatus for dispensing a substitute product, comprising:
means for receiving a selection of a first product from a purchaser;
means for retrieving a substitute product identifier corresponding to a substitute product when the first product is not available; and
means for offering the substitute product to the purchaser.

65. An apparatus for dispensing a substitute product, comprising:
a storage device; and
a processor connected to the storage device,
the storage device storing a program for controlling the processor; and
the processor operative with the program to:
receive a selection of a first product from a purchaser; and
when the first product is not available,
retrieve a substitute product identifier corresponding to a substitute product; and
offer the substitute product to the purchaser.

66. A computer readable medium encoded with processing instructions for implementing by a processor a method for dispensing a substitute product, the method comprising:
receiving a selection of a first product from a purchaser; and
if the first product is not available,
retrieving a substitute product identifier corresponding to a substitute product; and
offering the substitute product to the purchaser.

67. An apparatus for dispensing a substitute product, comprising:
means for measuring a demand for each of a plurality of products;
means for determining from the demand a substitute product for a first product; and
means for storing, for the first product, a substitute product identifier corresponding to the substitute product.

68. An apparatus for dispensing a substitute product, comprising:
a storage device; and
a processor connected to the storage device,
the storage device storing a program for controlling the processor; and
the processor operative with the program to:
measure a demand for each of a plurality of products;
determine from the demand a substitute product for a first product; and
store, for the first product, a substitute product identifier corresponding to the substitute product.

69. A computer readable medium encoded with processing instructions for implementing by a processor a method for dispensing a substitute product, the method comprising:
measuring a demand for each of a plurality of products;
determining from the demand a substitute product for a first product; and
storing, for the first product, a substitute product identifier corresponding to the substitute product.

70. An apparatus for dispensing a substitute product, comprising:
means for determining an average selection time;
means for detecting a purchaser;
means for measuring a time from a detection of the purchaser; and
means for offering a first product to the purchaser when the time is greater than the average selection time.

71. An apparatus for dispensing a substitute product, comprising:
a storage device; and
a processor connected to the storage device,
the storage device storing a program for controlling the processor; and
the processor operative with the program to:
determine an average selection time;
detect a purchaser;
measure a time from a detection of the purchaser; and
if the time is greater than the average selection time;
offer a first product to the purchaser.

72. A computer readable medium encoded with processing instructions for implementing by a processor a method for dispensing a substitute product, the method comprising:
determining an average selection time;
detecting a purchaser;
measuring a time from a detection of the purchaser; and
if the time is greater than the average selection time;
offering a first product to the purchaser.

73. An apparatus for measuring a demand of an unavailable product offered by a dispensing device, comprising:
means for receiving a selection of a product;
means for determining an availability of the product; and
means for storing an indication that the selected product is unavailable when the product is unavailable.

74. An apparatus for measuring a demand of an unavailable product offered by a dispensing device, comprising:
a storage device; and
a processor connected to the storage device,
the storage device storing a program for controlling the processor; and
the processor operative with the program to:
receive a selection of a product;
determine an availability of the product; and
if the product is unavailable:
store an indication that the selected product is unavailable.

75. A computer readable medium encoded with processing instructions for implementing by a processor a method for measuring a demand of an unavailable product offered by a dispensing device, the method comprising:
receiving a selection of a product;
determining an availability of the product; and
if the product is unavailable:
storing an indication that the selected product is unavailable.
